(19) United States
(12) Patent Application Publication
(10) Pub. No.: US 2009/0287792 A1
(43) Pub. Date: Nov. 19, 2009

(54) METHOD OF PROVIDING SERVICE RELATING TO CONTENT STORED IN PORTABLE STORAGE DEVICE AND APPARATUS THEREFOR

(76) Inventors: Hyo-jun KIM, Yongin-si (KR); Dong-jun SHIN, Hwaseong-si (KR); Hee-gyu KIM, Seongnam-si (KR); Seung-woo RYU, Seoul (KR)

Correspondence Address: Charles Y. Park, P.O. Box 34175, Washington DC, DC, 20043, US

(21) Appl. No.: 12/466,530

(22) Filed: May 15, 2009

(30) Foreign Application Priority Data
May 16, 2008 (KR) 10-2008-0045483

(51) Int. Cl. G06F 15/167; G06F 13/42

(52) U.S. Cl. 709/212; 710/105

(57) ABSTRACT

Provided are a method of providing a service relating to content stored in a portable storage device to an external device, and an apparatus therefor. The method includes outputting a user interface to manage information relating to contents stored in the portable storage device through a display unit associated with the external device, receiving a command to select content from among the contents through the output user interface, executing a service corresponding to the content selected based on the command, and providing a result of executing the service to the external device.

### CROSS-REFERENCE TO RELATED PATENT APPLICATION(S)

This application claims the benefit under 35 U.S.C. §119(a) of a Korean Patent Application No. 10-2008-0045483, filed on May 16, 2008, in the Korean Intellectual Property Office, the disclosure of which is incorporated herein in its entirety by reference.

### BACKGROUND

1. Field

The following description relates to a method of providing a service relating to content stored in a portable storage device and an apparatus therefor.

2. Description of the Related Art

A user is able to carry various contents by storing the contents in a portable storage device such as a flash drive, thumb drive, and universal serial bus (USB) memory.

FIG. 1 illustrates a conventional USB memory 100. Referring to FIG. 1, the USB memory 100 includes an USB controller 110 and a storage unit 120. Generally, the USB controller 110 reads contents stored in the storage unit 120 and outputs the contents to an external device (not shown) connected to the USB memory 100. Also, the USB controller 110 receives contents from the external device and stores the contents to the storage unit 120. Here, the USB memory 100 typically reads/writes using a SCSI over USB protocol.

FIG. 2 illustrates an operation of a conventional portable storage device 210. Referring to FIG. 2, the portable storage device 210 is connected to a host system 220. Here, the host system 220 denotes a device such as a personal computer (PC) having a separate power source and processor. The host system may include a file system 222, a photo viewer 224, and a music player 226, as shown in FIG. 2.

The file system 222 manages contents stored in the host system 220 and stores the contents read from the portable storage device 210 in the host system 220.

The photo viewer 224 and the music player 226 reproduce contents depending on the type of contents stored in the portable storage device 210 or the host system 220. For example, when the content is an image file, the photo viewer 224 outputs the image file for display and when the content is an audio file, the music player 226 reproduces the audio file.

As such, since a conventional portable storage device merely performs a read/write function, a user interface provided from an external device is used to manage the contents stored in the portable storage device. Also, an application of the external device is relied on to execute the contents.

Thus, to access the contents of a portable storage device, a user may need to first become familiar with a user interface and an application provided by an external device for each different external device the user comes across. In addition, since the user interface provided by the external device is typically formed of a directory structure, in order to manage the contents, the user, who may well not be familiar with the directory structure, may experience difficulty in managing the contents.

### SUMMARY

According to one general aspect, there is provided a method of providing a service relating to content stored in a portable storage device to an external device, the method including outputting a user interface to manage information relating to contents stored in the portable storage device to be displayed through a display unit associated with the external device, receiving a command to select content from among the contents through the output user interface, executing a service corresponding to the content selected based on the command, and providing a result of executing the service to the external device.

The user interface and the service may be formed in a graphic-based form or in a web browser form, and the portable storage device may include applications to execute the user interface and the service.

The providing of the result may include providing the result of executing the service to the external device through a communication using a web protocol.

The method may further include downloading contents stored in the external device to the portable storage device based on a command through the output user interface, wherein the receiving of the command to select the content includes receiving the command to select the content from among the contents stored in the portable storage device and the contents downloaded from the external device.

The method may further include refreshing the user interface based on a type or metadata of the downloaded contents, wherein receiving the command to select the content includes receiving the command to select the content through the refreshed user interface.

The portable storage device may not include its own power source and display unit and in response to the portable storage device being connected to the external device, a power source of the external device may be applied to the portable storage device.

The method may further include storing e-mails stored in the external device to the portable storage device, in response to the portable storage device being connected to the external device, wherein the receiving of the commend to select the content includes receiving the command to select the content from among the contents stored in the portable storage device and the e-mails stored in the external device.

The method may further include performing a user authentication of a user to execute the service, in response to the portable storage device being connected to the external device, wherein the outputting of the user interface includes outputting the user interface in response to the user being qualified as a result of the user authentication.

The portable storage device may be a universal serial bus (USB) memory and the external device may be one of an MP3 player, a PMP, a laptop, and a PC.

The information relating to the contents may include at least one of a content name, a content type, and an image corresponding to content, and the result of executing the service may include at least one of output of an image file, output of a text file, reproduction of an audio file, and reproduction of a video file.

The portable storage device may be connectable to the external device in wired or wireless fashion.

According to another aspect, there is provided a portable storage device to provide a service relating to content to an external device, the portable service device including a data storage unit configured to store contents, a service management unit configured to execute a user interface to manage information relating to the contents stored in the data storage unit and to execute services corresponding to the contents, and a service controller configured to control the user interface to be output to be displayed through a display unit associated with the external device and to control a result of executing a service corresponding to content selected based on a command input through the user interface provided to the external device.

The user interface and the service may be formed in a graphic-based form or in a web browser form, and the service management unit may include applications to execute the user interface and the service.

The service controller may control the result of executing the service to be provided to the external device through a communication using a web protocol.

The service controller may control contents stored in the external device to be downloaded to the data storage unit based on a command input through the user interface output to the external device.

The service controller may control the user interface to be refreshed based on a type or metadata of the contents downloaded to the data storage unit.

The portable storage device may not include its own power source and display unit and in response to the portable storage device being connected to the external device, a power source of the external device may be applied to the portable storage device.

The service controller may control e-mails stored in the external device to be stored in the portable storage device, in response to the portable storage device being connected to the external device.

The service controller may perform a user authentication of a user to execute the service, in response to the portable storage device being connected to the external device, and control the user interface to be output in response to the user being qualified as a result of the user authentication.

The portable storage device may be a universal serial bus (USB) memory and the external device may be one of an MP3 player, a PMP, a laptop, and a PC. The information relating to the contents may include at least one of a content name, a content type, and an image corresponding to content, and the result of executing the service may include at least one of output of an image file, output of a text file, reproduction of an audio file, and reproduction of a video file. The portable storage device may be connectable to the external device in wired or wireless fashion.

According to still another aspect, there is provided a computer readable storage medium storing a program to provide a service relating to content stored in a portable storage device to an external device, comprising instructions to cause a computer to output a user interface to manage information relating to contents stored in the portable storage device to be displayed through a display unit associated with the external device, receive a command to select content from among the contents through the output user interface, execute a service corresponding to the content selected based on the command, and provide a result of executing the service to the external device.

Other features and aspects will be apparent from the following detailed description, the drawings, and the claims.

### BRIEF DESCRIPTION OF THE DRAWINGS

FIG. 1 is a diagram illustrating a conventional universal serial bus (USB) memory.

FIG. 2 is a diagram illustrating an operation of a conventional portable storage device with respect to a host system.

FIG. 3 is a block diagram illustrating an exemplary portable storage device to provide a service relating to content to an external device.

FIG. 4 is a block diagram illustrating another exemplary portable storage device to provide a service relating to content to an external device.

FIG. 5 is a block diagram illustrating an exemplary user interface.

FIG. 6 is a flowchart illustrating an exemplary method of providing a service relating to content stored in a portable storage device to an external device.

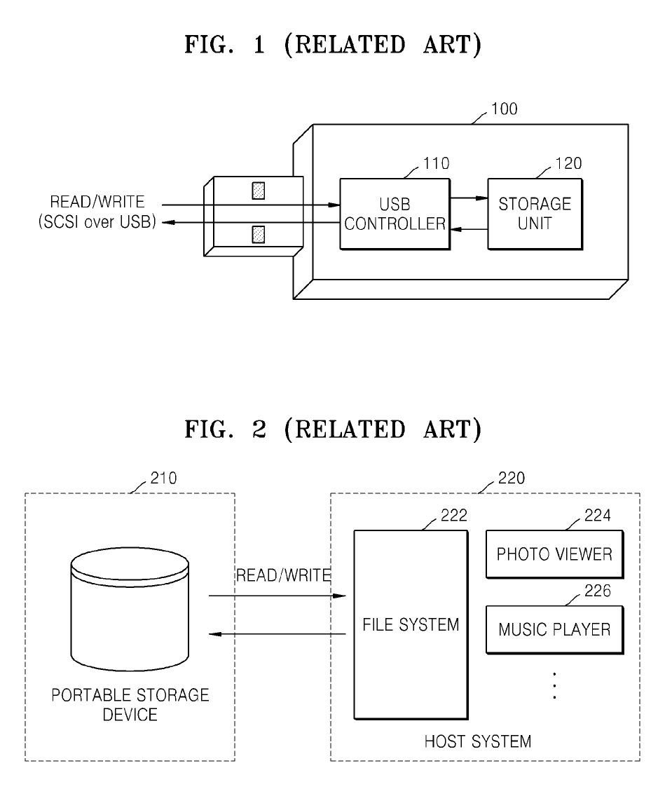

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

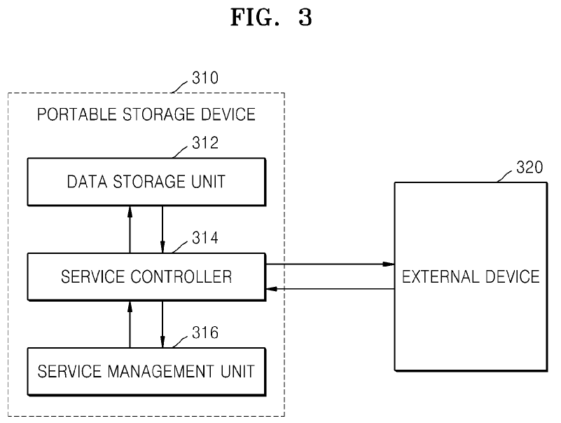

FIG. 3 illustrates an exemplary portable storage device 310 to provide a service relating to content to an external device 320.

Referring to FIG. 3, the portable storage device 310 includes a data storage unit 312, a service controller 314, and a service management unit 316. For convenience of description, the external device 320 is illustrated as shown.

Contents of various types may be stored in the data storage unit 312.

The service management unit 316 executes a user interface for managing information relating to the contents stored in the data storage unit 312 and executes a service corresponding to a particular content.

For example, information relating to content may be at least one of a name of the content, a type of the content, and an image(s) corresponding to the content.

The service management unit 316 may include applications to execute the user interface and the services.

For example, the service management unit 316 may include at least one of an application to output an image file, an application to output a text file, an application to reproduce an audio file, and an application to reproduce a video file.

Accordingly, a user may use the user interface and the applications included in the service management unit 316 to manage the contents, even when the portable storage device 310 is connected to an external device 320 not familiar to the user, and to execute services corresponding to the contents selected through the user interface.

The user interface and services may be configured in a graphic-based form of the portable storage device 310 or in a web browser format. Accordingly, although the user may not be familiar with a directory structure of the external device 320, the user can intuitively manage the contents using the user interface of the portable storage device 310.

The service controller 314 controls the user interface executed through the service management unit 316 to be output to the external device 320 and displayed through, for example, a display unit of the external device 320, and controls the result of the services executed through the service management unit 316 to be provided to the external device 320.

For example, when the user selects content through the user interface which is output to and displayed by the external device 320, the service controller 314 uses one or more applications included in the service management unit 316 and executes a service corresponding to the selected content, so as to provide the result of executing the service to the external device 320.

Here, the result of executing the service may be one or more of, for example, outputting an image file, outputting a text file, reproducing an audio file, and reproducing a video file.

The user may also use the user interface which is output to and displayed by the external device 320 and to store the contents or e-mails of the external device 320 in the data storage unit 312 of the portable storage device 310. For example, the user may use the interface to store the contents of the external device 320 in the portable storage device 310 in a drag and drop manner. As another example, when the portable storage device 310 is connected to the external device 320, the portable storage device 310 may be configured such that, for example, e-mails in the external device 320 are automatically stored in the portable storage device 310.

In another aspect, the service controller 314 may provide the result of executing the service through a communication using a web protocol to the external device 320. For example, assuming the portable storage device 310 is a universal serial bus (USB) memory, the service controller 314 may provide the result of executing the service through a communication using a TCP/IP over a USB protocol to the external device 320.

In this case, the portable storage device 310 may function as a web server and the external device 320 may function as a web client. Accordingly, the user can manage the contents stored in the portable storage device 310 using the user interface in a web browser manner which is output to and displayed by the external device 320. Thus, the user can intuitively manage the contents.

In addition, a digital rights management (DRM) technology and a user authentication technology supported by the existing web server may be applied to the portable storage device 310 where the service controller 314 of the portable storage device 310 functions as a web server, as described above. For example, when the portable storage device 310 is connected to the external device 320, the service controller 314 performs a user authentication with respect to the user to execute the service corresponding to the content stored in the portable storage device 310. As a result of the user authentication, the service controller 314 may control the user interface to be output to the external device 320 only when the user is authenticated as qualified.

The portable storage device 310 may not include its own power source and a display unit, and instead, may be configured to receive power from a source of the external device 320 when the portable storage device 310 is connected to the external device 320. As an example, the portable storage device 310 may be a USB memory and the external device 320 may be an MP3 player, a PMP, a laptop, a PC, and the like.

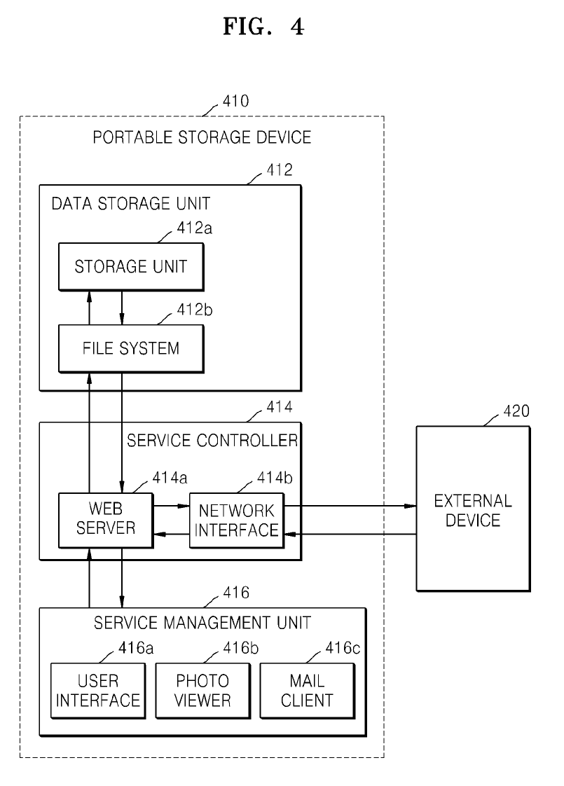

FIG. 4 illustrates another exemplary portable storage device 410 to provide a service relating to content to an external device 420.

Referring to FIG. 4, the portable storage device 410 includes a data storage unit 412, a service controller 414, and a service management unit 416.

The data storage unit 412 includes a storage unit 412a and a file system 412b, the service controller 414 includes a web server 414a and a network interface 414b, and the service management unit 416 includes a user interface 416a, a photo viewer 416b, and a mail client 416c.

An exemplary operation of the portable storage device 410 will be described below with reference to FIG. 4.

When the portable storage device 410 is connected to the external device 420, a power source from the external device 420 may be applied to the portable storage device 410. Here, the portable storage device 410 may be connected in wired or wireless fashion. For example, the portable storage device 410 may be connected to the external device 420 using a wireless LAN scheme or a Bluetooth scheme. When the portable storage device 410 is a pluggable device such as a USB memory, the portable storage device 410 may be connected to the external device 420 by being plugged into the external device 420.

In response to the portable storage device 410 being connected to the external device 420, the web server 414a controls the service management unit 416 to execute the user interface 416a. When the user interface 416a is executed by the service management unit 416, the web server 414a controls the user interface 416a to be output to and displayed by a display unit of the external device 420 through the network interface 414b. Here, the network interface 414b functions as an intermediate so as to provide the result of executing the user interface to the external device 420.

When a user inputs a command to select content from among the contents stored in the data storage unit 412 through the user interface displayed from the external device 420, the network interface 414b delivers the command to the web server 414a and the web server 414a uses an application from among the applications included in the service management unit 416 to control the service corresponding to the selected content to be executed.

For example, when the selected content is an image file, the web server 414a reads the selected image file from the data storage unit 412 and controls the read image file to be output using the photo viewer 416b. When the selected content is an e-mail, the web server 414a reads the selected e-mail from the data storage unit 412 and controls the e-mail to be output using the mail client 416c.

Here, the file system 412b in the data storage unit 412 reads the selected content from the storage unit 412a and provides the read content to the web server 414a.

In another aspect, the web server 414a downloads content from the external device 420 through the network interface 414b and stores the downloaded content to the data storage unit 412. In this case, the file system 412b in the data storage unit 412 stores the content, which is delivered from the external device 420 through the web server 414a, to the storage unit 412a.

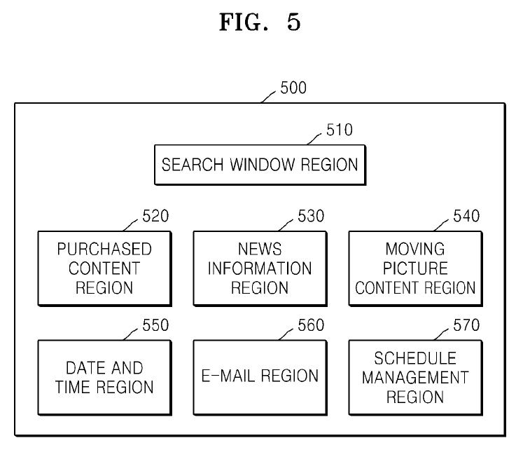

FIG. 5 illustrates an exemplary user interface 500.

Referring to FIG. 5, the user interface 500 includes a search window region 510, a purchased content region 520, a news information region 530, a moving picture content region 540, a date and time region 550, an e-mail region 560, and a schedule management region 570. For example, each region is formed of at least one of an image and text.

The search window region 510 is where content stored in a portable storage device, for example, consistent with FIG. 3 or 4, is searched for using a search word. Here, the search word may be information relating to metadata such as data of the content being generated, a composer relating to the content, a genre of the content or the like.

The purchased content region 520 is where information relating to the contents purchased by a user through, for example, Internet is output.

The news information region 530 is where information relating to news received through, for example, Internet is output.

The moving picture content region 540 is where information relating to moving picture contents received through, for example, Internet and/or information relating to moving picture contents stored in the portable storage device is output.

The date and time region 550 is where current data and time are output.

The e-mail region 560 is where information relating to e-mails stored in the portable storage device and/or information relating to e-mails stored in the external device is output.

The schedule management region 570 is where information for managing a schedule of a user is output.

Referring to FIG. 5, the user interface 500 may not be formed by a directory structure, and instead, formed by a web browser structure using images and text. Thus, a user may manage the contents intuitively.

It is understood that the regions forming the user interface 500 are not limited to the regions described above, and in other implementations, various other regions such as an audio content region, an image content region and the like may be further included. Various combinations are possible.

In another aspect, when content stored in an external device is downloaded to the portable storage device, the user interface 500 may be refreshed based on the type or metadata of the downloaded content.

For example, when the content downloaded to the portable storage device is moving picture content, the user interface 500 may be refreshed so that information can be output relating to the moving picture content downloaded to the moving picture content region.

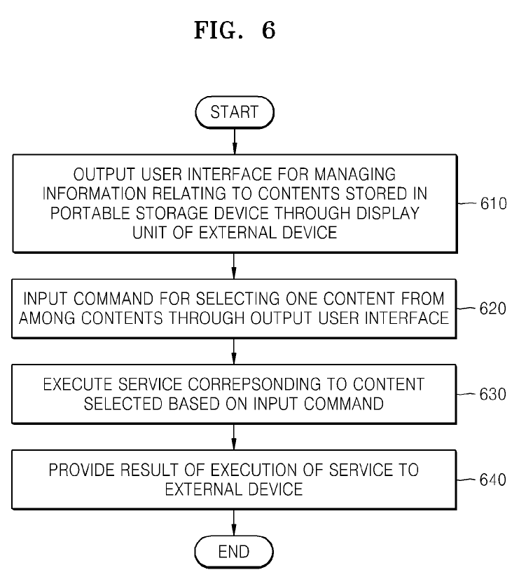

FIG. 6 shows a flowchart illustrating an exemplary method of providing a service relating to content stored in a portable storage device to an external device. The one or more operations of the method may be performed by, for example, a portable storage device consistent with FIG. 3 or 4.

In operation 610, a user interface for managing information relating to contents stored in a portable storage device is output so as to be displayed by a display unit of an external device.

In operation 620, a command for selecting content from among the contents is input to the portable storage device through the output user interface.

In operation 630, a service corresponding to the content selected based on the command is executed.

In operation 640, a result of executing the service is provided to the external device.

According certain example(s) described above, a user interface of a portable storage device may be used to manage contents so that the contents stored in, for example, the portable storage device can be managed through that user interface even when the portable storage device is connected to different external devices.

The methods described above may be recorded, stored, or fixed in one or more computer-readable media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of providing a service relating to content stored in a portable storage device to an external device, the method comprising:
outputting a user interface to manage information relating to contents stored in the portable storage device to be displayed through a display unit associated with the external device;
receiving a command to select content from among the contents through the output user interface;
executing a service corresponding to the content selected based on the command; and
providing a result of executing the service to the external device.

2. The method of claim 1, wherein:
the user interface and the service are formed in a graphic-based form or in a web browser form, and
the portable storage device includes applications to execute the user interface and the service.

3. The method of claim 1, wherein the providing of the result comprises providing the result of executing the service to the external device through a communication using a web protocol.

4. The method of claim 1, further comprising downloading contents stored in the external device to the portable storage device based on a command through the output user interface, wherein the receiving of the command to select the content comprises receiving the command to select the content from among the contents stored in the portable storage device and the contents downloaded from the external device.

5. The method of claim 4, further comprising refreshing the user interface based on a type or metadata of the downloaded contents, wherein receiving the command to select the content comprises receiving the command to select the content through the refreshed user interface.

6. The method of claim 1, wherein the portable storage device does not include its own power source and display unit and in response to the portable storage device being connected to the external device, a power source of the external device is applied to the portable storage device.

7. The method of claim 6, further comprising storing e-mails stored in the external device to the portable storage device, in response to the portable storage device being connected to the external device, wherein the receiving of the commend to select the content comprises receiving the command to select the content from among the contents stored in the portable storage device and the e-mails stored in the external device.

8. The method of claim 6, further comprising performing a user authentication of a user to execute the service, in response to the portable storage device being connected to the external device, wherein the outputting of the user interface comprises outputting the user interface in response to the user being qualified as a result of the user authentication.

9. The method of claim 1, wherein the portable storage device is a universal serial bus (USB) memory and the external device is one of an MP3 player, a PMP, a laptop, and a PC.

10. The method of claim 1, wherein:
the information relating to the contents comprises at least one of a content name, a content type, and an image corresponding to content, and
the result of executing the service comprises at least one of output of an image file, output of a text file, reproduction of an audio file, and reproduction of a video file.

11. The method of claim 1, wherein the portable storage device is connectable to the external device in wired or wireless fashion.

12. A portable storage device to provide a service relating to content to an external device, the portable service device comprising:
a data storage unit configured to store contents;
a service management unit configured to execute a user interface to manage information relating to the contents stored in the data storage unit and to execute services corresponding to the contents; and
a service controller configured to control the user interface to be output to be displayed through a display unit associated with the external device and to control a result of executing a service corresponding to content selected based on a command input through the user interface provided to the external device.

13. The device of claim 12, wherein:
the user interface and the service are formed in a graphic-based form or in a web browser form, and
the service management unit includes applications to execute the user interface and the service.

14. The device of claim 12, wherein the service controller controls the result of executing the service to be provided to the external device through a communication using a web protocol.

15. The device of claim 12, wherein the service controller controls contents stored in the external device to be downloaded to the data storage unit based on a command input through the user interface output to the external device.

16. The device of claim 15, wherein the service controller controls the user interface to be refreshed based on a type or metadata of the contents downloaded to the data storage unit.

17. The device of claim 12, wherein the portable storage device does not include its own power source and display unit and in response to the portable storage device being connected to the external device, a power source of the external device is applied to the portable storage device.

18. The device of claim 17, wherein the service controller controls e-mails stored in the external device to be stored in the portable storage device, in response to the portable storage device being connected to the external device.

19. The device of claim 17, wherein the service controller performs a user authentication of a user to execute the service, in response to the portable storage device being connected to the external device, and controls the user interface to be output in response to the user being qualified as a result of the user authentication.

20. The device of claim 12, wherein the portable storage device is a universal serial bus (USB) memory and the external device is one of an MP3 player, a PMP, a laptop, and a PC.

21. The device of claim 12, wherein:
the information relating to the contents comprises at least one of a content name, a content type, and an image corresponding to content, and
the result of executing the service comprises at least one of output of an image file, output of a text file, reproduction of an audio file, and reproduction of a video file.

22. The device of claim 12, wherein the portable storage device is connectable to the external device in wired or wireless fashion.

23. A computer readable storage medium storing a program to provide a service relating to content stored in a portable storage device to an external device, comprising instructions to cause a computer to:
output a user interface to manage information relating to contents stored in the portable storage device to be displayed through a display unit associated with the external device;
receive a command to select content from among the contents through the output user interface;
execute a service corresponding to the content selected based on the command; and
provide a result of executing the service to the external device.
